(19) United States
(12) Patent Application Publication
(10) Pub. No.: US 2025/0348940 A1
(43) Pub. Date: Nov. 13, 2025

(54) SYSTEM FOR COMPREHENSIVE ASSET VALUATION AND OPTIMIZATION AND A METHOD THEREOF

(71) Applicant: Thomas Hecht, Cambridge, MA (US)

(72) Inventor: Thomas Hecht, Cambridge, MA (US)

(21) Appl. No.: 18/658,420

(22) Filed: May 8, 2024

(51) Int. Cl. G06Q 40/06; G06Q 30/0204

(52) U.S. Cl. CPC G06Q 40/06; G06Q 30/0204

(57) ABSTRACT

The present disclosure relates to a method and a system for asset valuation and optimization. The method is implemented through a set of instructions executed by a processor. The method includes registering a participant. The method further includes capturing asset declarations representing assets of the participant. The method also includes disaggregating the captured asset declarations into similar asset groups based on predefined parameters associated with an asset class and a type of participant. The method further includes classifying the similar asset groups into a plurality of thematic pools. The method also includes synthesizing actionable strategies for each thematic pools. The method further includes categorizing the actionable strategies into supply and demand segments, aligning with current market needs and capability of the participant.

### FIELD OF THE INVENTION

The present disclosure generally relates to a field of asset management and optimization. More specifically, the present disclosure relates to systems and methods to facilitate comprehensive valuation, management, and optimization of diverse asset types.

### BACKGROUND

Typically, the management and optimization of assets, including tangible, intangible, and alternative assets, have presented multifaceted challenges across various industries. Traditional asset management systems often fall short in capturing full spectrum of value that assets may hold, particularly in rapidly evolving markets. The limitation lies in an inability of the traditional asset management systems to adapt to market changes dynamically. Further, the traditional asset management system cannot efficiently aggregate and analyze diverse asset types, and facilitate seamless transactions that align with both supply and demand needs. Historically, asset valuation techniques have largely relied on conventional appraisal methods, which often fail to account for rapidly changing market conditions and the emerging value of intangible and alternative assets.

Existing solutions in asset management typically involve fragmented systems that handle different asset types in isolation, leading to inefficiencies and missed opportunities for optimization. Moreover, these fragmented systems lack transparency and collaborative mechanisms necessary for maximizing asset value realization among stakeholders. As a result, participants are often unable to leverage collective insights or access a comprehensive view of asset potentials, leading to suboptimal decision-making and value loss.

While some advancements have been made in incorporating artificial intelligence (AI) to address above mentioned challenges. Existing implementations often remain limited in scope.

Further, an integration of digital marketplace platforms has emerged as a promising avenue for enhancing asset transactions' efficiency and transparency. Yet, the effectiveness of these platforms is frequently hampered by the lack of sophisticated matching algorithms and smart contract technologies that can adequately address the complexities of matching supply with demand in a nuanced manner that accounts for the multifaceted nature of assets and their potential synergies. Also, the existing systems doesn't adequately support sharing of insights and collaborative value enhancement across different market participants.

Furthermore, with the growing complexity of asset portfolios and the stringent regulatory landscape, managing compliance and mitigating risks have become more challenging. The traditional asset management systems often lack ability to adapt to new regulations or to effectively manage diverse risks associated with various asset types. Another critical aspect that has been overlooked by existing solutions is the importance of user experience and technological integration. The existing asset management systems must be user-friendly and seamlessly integrate with other business systems to provide a cohesive and efficient operational framework. This includes leveraging cloud computing, mobile technology, and user-centric design principles to ensure accessibility, scalability, and a streamlined user experience.

Hence, there is a need for a system that addresses the above-mentioned challenges and not only harnesses power of artificial intelligence for asset management and optimization but also incorporates a digital marketplace to facilitate transactions.

The drawbacks/difficulties/disadvantages/limitations of the existing techniques explained in the background are just for exemplary purposes and the disclosure would never limit its scope only to such drawbacks/difficulties/disadvantages/limitations. A person skilled in the art would understand that the present disclosure and the below mentioned description may also solve other problems or overcome the other drawbacks/difficulties/disadvantages/limitations of the existing arts which are not explicitly captured above.

### SUMMARY

This summary is provided to introduce a selection of concepts, in a simplified format, that are further described in the detailed description of the invention. This summary is neither intended to identify essential inventive concepts of the invention nor is it intended for determining the scope of the invention.

According to an embodiment of the present disclosure, a method for asset valuation and optimization is disclosed. The method is implemented through a set of instructions executed by a processor. The method includes registering a participant. The method further includes capturing asset declarations representing assets of the participant. The method also includes disaggregating the captured asset declarations into similar asset groups based on predefined parameters associated with an asset class and a type of the participant. The method further includes classifying the similar asset groups into a plurality of thematic pools. The method also includes synthesizing actionable strategies for each thematic pool. The method further includes categorizing the actionable strategies into supply and demand segments, aligning with current market needs and capability of the participant.

According to an embodiment of the present disclosure, a system for asset valuation and optimization. The system includes a participant registration module configured to register a participant and assets declared by the participant. The system further includes an asset disaggregating module for disaggregating the declared assets into smallest practical units and categorizes the declared assets into similar assets for optimized management and valuation. The system also an artificial intelligence (AI) pooling module configured to pool the similar assets into thematic pools. The thematic pools are based on one or more of complementary, adjacent, or tangential characteristics.

The system includes a thematic analysis module. The system also includes a strategy formulation module configured to formulate a strategy based on a current market condition and anticipate future trends from the thematic pools. The assets are dynamically reevaluated, emerging opportunities are identified, and strategies are adjusted in accordance with the reevaluated assets and new opportunities based on the current market condition and the future trends. The system also includes a market segmentation module for integrating a digital marketplace platform for matching a supply and demand of the declared asset. The system further includes a transaction module for facilitating transactions of the declared assets.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIGS. 1-8 illustrate signal flow diagrams of the system for asset valuation and optimization, according to an embodiment of the present disclosure;

FIG. 9 illustrates a process flowchart depicting a method of participation registration to final transactions, according to an embodiment of the present disclosure;

FIGS. 10-12 illustrate a plurality of user interfaces of the system, according to an embodiment of the present disclosure; and

FIG. 13 illustrates a signal flow chart depicting a hybrid marketplace for optimizing asset transaction, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION OF DRAWINGS

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment”, and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or additional devices or additional sub-systems or additional elements or additional structures or additional components.

The present disclosure proposes a method and a system for asset valuation and optimization. The present invention relates to a system and method for enhancing asset management and optimization across various sectors by leveraging artificial intelligence (AI) and digital marketplace technologies. The system includes modules for participant registration, asset declaration, and disaggregation into similar asset groups. Utilizing AI algorithms, the system pools these groups into thematic pools based on complementary, adjacent, or tangential characteristics, synthesizing actionable strategies for asset optimization. These strategies are then categorized into supply and demand segments, aligning with market needs and participant capabilities. The invention further incorporates a digital marketplace with advanced matching algorithms and smart contract technology, facilitating efficient, transparent, and secure transactions.

Additionally, the system features modules for contract execution, compliance monitoring, and post-transaction audits, ensuring holistic management of tangible, intangible, and alternative assets. Through transparency and collaboration, the system gradually builds value, allowing the participants to share in the benefits generated from their inputs, thereby fostering innovation, sustainability, and economic efficiency across industries.

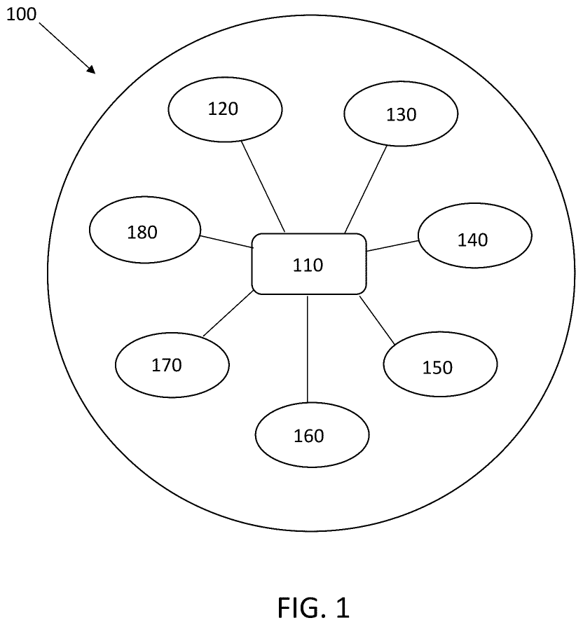

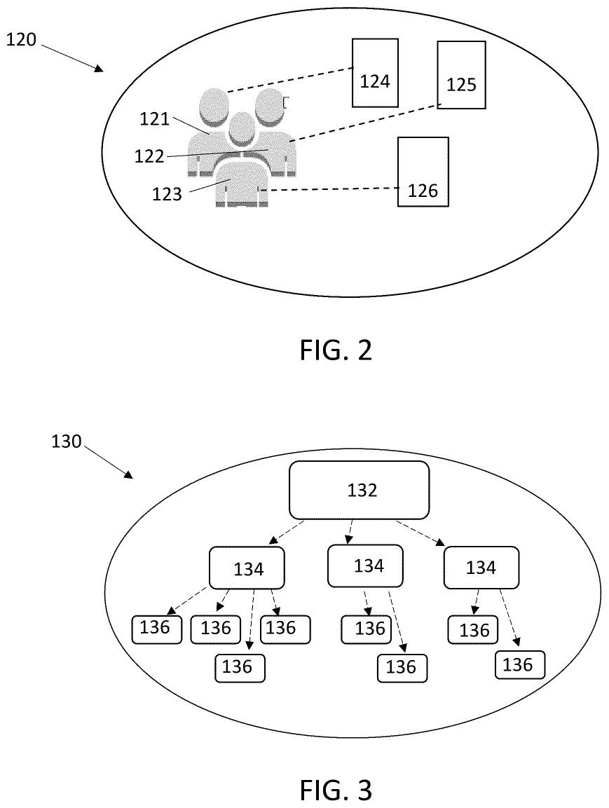

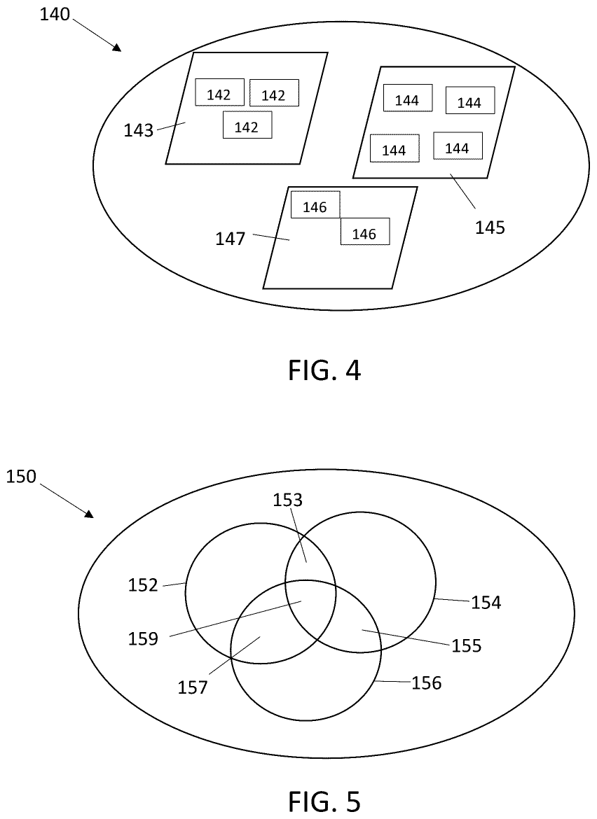

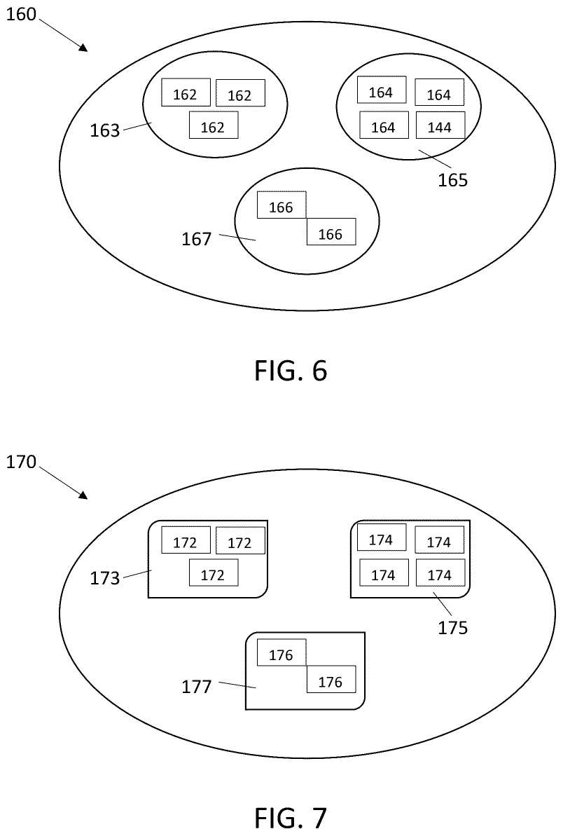

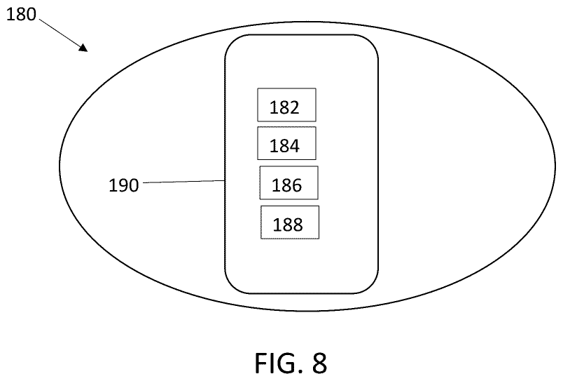

FIGS. 1-8 illustrate signal flow diagrams of the system 100 for asset valuation and optimization, according to an embodiment of the present disclosure.

An asset includes both tangible and intangible assets. The system 100 may be capable of calculating a relative value of the asset that may be significantly influenced by factors such as scarcity, demand, personal circumstances, and societal trends. In one example, the tangible assets may include, but is not limited to, real estate, vehicles, machinery and equipment, inventory (products for sale), and physical commodities. Further, the system 100 may be able to categorize the relative value of the real estate as high due to a scarcity, and universal need for housing and commercial spaces. Further, the relative value of the real estate increases with location desirability and economic development. In another example, the system 100 may be able to gauge the relative value of vehicles as medium to high, but depreciates over time as the vehicles are essential for personal transportation or business logistics.

In yet another example, the system 100 may provide a relative value of the machinery and equipment as variable. The relative value of machinery and equipment is high for industries, further depends on a type of equipment. Also, the system 100 takes into account the relative value of the machinery and equipment that depreciates with time. In one example, the system 100 may categorize the inventory having a medium relative value that is essential for retail and manufacturing businesses. Further, the value of the inventory depends on demand and market saturation. In another example, the system 100 may categorize the physical commodities such as gold or oil, having a high relative value, based on a current market demand and role of the physical commodities in economic stability.

The intangible assets include intellectual property (IP) including, but not limited to, trademarks, goodwill, patents, etc. In an example, the system 100 may calculate the relative value of the IP and may categorize the specific IP between low to high, based on the market value. The goodwill, brand recognition, and the trademark may have high relative value as such IP require time to build. Further, the intangible assets may include the connections build by a business including the network and relationships. The system 100 may categorize the connections and networks with high relative value as the connections may lead to opportunities, collaborations, and access to resources not readily available through other means. Furthermore, the intangible assets may also include data having a high relative value in today's digital age. Analyzing the data may yield insights into consumer behavior, operational efficiency, and predictive modeling. The intangible assets also include unused time or resources.

The system 100 may correspond to a stand-alone system or a system 100 based in a server/cloud architecture. The system 100 may correspond to, but is not limited to, a server, a personal computing device, a user equipment, a laptop, a tablet, a mobile communication device, and so forth.

In an embodiment, the system 100 may include a processing unit 110. The processing unit 110 may include, but is not limited to, a memory, module(s), and a database. The processing unit may be configured to register a participant in the system 100; capturing and recording declarations of assets owned by the participant; disaggregating declared assets into groups of similar assets; utilizing artificial intelligence algorithms to pool these groups into thematic pools based on characteristics; generating actionable strategies derived from analysis of thematic pools; and categorizing these strategies into segments of supply and demand, tailored to align with both current market conditions and future trends.

The processing unit 110 may be a single processing unit or a number of units, all of which may include multiple computing units. The processing unit 110 may be implemented as one or more microprocessing units, microcomputers, microcontrollers, digital signal processing units, central processing units, state machines, logic circuitries, and/or any devices that manipulate signals based on operational instructions. Among other capabilities, the processing unit 110 may be configured to fetch and execute computer-readable instructions and data stored in the memory.

The memory may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes, but is not limited to the same.

The module(s), amongst other things, include routines, programs, objects, components, data structures, etc., which perform particular tasks or implement data types, but is not limited to the same. The module(s) may also be implemented as, signal processing unit(s), state machine(s), logic circuitries, and/or any other device or component that manipulates signals based on operational instructions.

The system 100 may include an interview module to facilitate interviews between a company and the participant. The interview module is configured to record and store data related to interview particulars accessible to both the company and the participant for mutual benefit.

The system 100 includes a registration module 120 where users 121, 122, 123 input an information, on data entry forms 124, 125, 126. The information may be related to a personal information of the participant or a declaration of assets of the participant.

The system 100 may further include an asset disaggregation module 130 represented by a series of funnels breaking down assets 134 into smaller units 136, with algorithms symbolized by gears or mathematical symbols.

Further, the system 100 includes an artificial intelligence (AI) pooling module 140 visualized with neural network graphics, showing the grouping of assets 142, 144, 146 into different pools 143, 145, 147.

The system 100 includes a thematic analysis module 150 depicted with an overlapping circles 152, 154, 156, symbolizing the grouping of pools into broader themes 153, 155, 157, 159. Further, the system 100 includes a strategy formulation module 160 showing flowcharts or strategy maps 163, 165, 167, indicating the development of actionable plans 162, 164, 166.

The thematic analysis module 150 analyzes assets based on the thematic pools. More specifically, the thematic analysis module 150 may identify patterns, trends, and synergies within these pools to inform strategic decisions. By understanding thematic interconnections, the module 150 may aid in recognizing underutilized assets or emerging sectors that could benefit from strategic investment or reallocation.

In an embodiment, the system 100 may enable pooling or aggregating of unused or excess credit limits from multiple lines of credit. In one example, if several individuals or entities have lines of credit with unused portions, the system 100 through the thematic analysis module 150 can pool the unused portions together to create a larger pool of available credit. When pooling these excess capacities, the system 100 may consider the quality of risk management practices associated with each line of credit. This means that not all excess capacities are treated equally and those with better risk management practices or lower risk profiles may have a higher weight or priority in the pooled capacity. Further, the pooled excess capacity can be utilized for various purposes, such as providing additional liquidity, funding new projects or ventures, or managing cash flow. By pooling these capacities, your system can optimize the use of available credit and improve overall efficiency in credit management.

The system 100 leverages underutilized assets by making them available to those who can derive value from them and thereby reducing waste and enhancing overall resource efficiency. Further, the system 100 may encourage entities from various sectors to collaborate, sharing insights and assets that would otherwise remain siloed, thus driving innovation and economic efficiency. Also, the system 100 may build a transparent ecosystem where the sharing of assets and information is streamlined thereby enabling participants to make informed decisions and capitalize on opportunities more effectively.

In an embodiment, the thematic pools are based on any of complementary, adjacent, or tangential characteristics of the similar asset group. The assets with complementary characteristics are those that, when combined, enhance each other's value or utility. The combination of such assets provides a synergy that results in greater effectiveness or efficiency than the sum of the assets operating independently. In one example related to a technological ecosystem, a software that enhances the functionality of hardware can be seen as complementary. Combining a powerful analytics platform (software) with high-performance computing hardware creates a solution more valuable than either component on its own, as the software leverages the hardware's capabilities to perform complex analyses more efficiently.

In an embodiment, assets with adjacent characteristics are those that are related or next to each other in terms of their application, market, or purpose but do not necessarily directly enhance each other's value. Grouping adjacent assets can target broader needs or opportunities within a related space. In an exemplary embodiment, the thematic pool focusing on the health sector might include assets like medical devices, health supplements, and telehealth services. While each serves different health-related needs, their adjacency in terms of market (healthcare) and purpose (improving health outcomes) allows for a diversified yet focused approach to investment or asset optimization within the healthcare industry.

In an embodiment, assets with tangential characteristics are those that might not be directly related in a straightforward or obvious way but are connected through less direct, more innovative, or emerging synergies. These connections are often speculative and based on emerging trends or innovative applications of the assets. In an exemplary embodiment, the asset pool combining renewable energy technologies with blockchain technology might be based on a tangential relationship where blockchain's secure, transparent transaction capabilities are applied to managing renewable energy distribution and trading, despite the primary functions of these assets not being inherently related.

The creation of thematic pools based on these characteristics allows for strategic asset management and optimization in several ways. Firstly, by identifying and leveraging the unique ways in which assets can complement, supplement, or innovate with each other, thematic pools can generate value beyond what individual assets could achieve in isolation. Further, grouping assets with different but related characteristics can help mitigate risks associated with market volatility, sector-specific downturns, or technological obsolescence. Especially with tangential pooling, there's an opportunity to anticipate and capitalize on emerging trends and cross-sector innovations, positioning the pooled assets at the forefront of market developments. In essence, the strategy behind forming thematic pools is to maximize the potential of assets by strategically leveraging their interrelationships, whether these are straightforward, complementary, broadly related, or innovatively connected. This approach not only enhances asset value and utility but also encourages a more dynamic and forward-thinking management strategy.

The system 100 may include a strategy formulation module 160 adapted to formulate strategies that align with current market conditions while also anticipating future trends. The module 160 may be adapted to consider an amount by which the assets may be optimized, either by leveraging current strengths or by positioning for future opportunities. The strategies might include diversifying investments into emerging themes, consolidating assets to strengthen core areas, or reallocating resources to exploit anticipated market shifts. Hence, the system 100 continuously monitors the market and the performance of thematic pools to dynamically reevaluate assets through a dynamic reevaluation module. The system 100 identifies emerging opportunities and adjusts strategies accordingly, ensuring that asset management remains agile and forward-looking. In one example, if a new technology emerges within a thematic pool that could disrupt the market, the system 100 can quickly pivot, advising on reallocating investments, or resources to capitalize on the trend.

In an embodiment, the system 100 may include a market segmentation module 170. The market segmentation module 170 may be adapted to integrate a digital marketplace platform designed to match a supply and demand of declared assets efficiently. The market segmentation module 170 segments the market to target specific buyer and seller groups, optimizing the visibility and appeal of assets. For a real estate asset within the thematic pool focused on sustainable development, the module 170 would match the properties with buyers specifically looking for eco-friendly living spaces, enhancing transaction success rates.

In an embodiment, the system 100 may include a transaction module 180 adapted to facilitate the actual buying, selling, or trading of assets within the platform. The transaction module 180 may ensure smooth, secure transactions, possibly including features like smart contracts, secure payment processing, and legal compliance checks. When the asset is identified for sale or trade, the transaction module manages the process from listing to completion, ensuring transparency, security, and efficiency.

One or more modules including, but not limited to, the thematic analysis module 150, the strategy formulation module 160, the dynamic reevaluation module, the market segmentation module 170, the transaction facilitation module 180, work in an integrated manner to provide a comprehensive asset management solution. In an embodiment, the thematic analysis module 150 identifies and categorizes assets, highlighting potential areas for optimization or growth. The strategy formulation module 160 leverages the analysis to craft actionable strategies that are responsive to both the current and future market landscapes. The dynamic reevaluation module ensures that these strategies are not static, as conditions change, the system 100 adapts thereby ensuring alignment with the latest market dynamics and opportunities. The market segmentation module 170 optimizes the marketplace platform, ensuring that assets reach their ideal target audience, enhancing both supply and demand matching. The transaction facilitation module 180 ensures that once a strategic decision is made, the transaction process is seamless, secure, and aligned with the overall strategy. Therefore, the system 100 may represent a holistic approach to asset management, prioritizing adaptability, strategic foresight, and market responsiveness to maximize asset value and performance over time.

As illustrated in the figure, the system 100 includes the market segmentation module 170 with graphs and charts 173, 175, 177, illustrating the categorization of strategies into supply and demand 172, 174, 176.

As illustrated in the figure, the system 100 includes the transaction module 180 is represented by a digital marketplace interface 190, indicating the facilitation of transactions 182, 184, 186, 188.

Further, the modules 120-180 may be implemented in hardware, instructions may be executed by the processing unit 110. The processing unit 110 may comprise a computer, a state machine, a logic array and/or any other suitable devices capable of processing instructions. The processing unit 110 may be a general-purpose processing unit which executes instructions to cause the general-purpose processing unit 110 to perform operations or, may be dedicated to performing the required functions. In some example embodiments, the modules may be machine-readable instructions (software, such as web-application, mobile application, program, etc.) which, when executed by the processing unit 110 perform any of the described functionalities.

In an implementation, the module may include the registration module 120, an asset disaggregation module 130, the AI pooling module 140, the thematic analysis module 150, the strategy formulation module 160, the market segmentation module 170, and the transaction module 180. The modules 120-180 may be in communication with each other. The database may serve, amongst other things, as a repository for storing data processed, received, and generated by one or more of the modules 120-180.

In an embodiment of the present disclosure, the modules 120-180 may be implemented as part of the processing unit 110. In another embodiment of the present disclosure, the modules 120-180 may be external to the processing unit 110. In yet another embodiment of the present disclosure, the modules 120-180 may be part of the memory. In another embodiment of the present disclosure, the modules 120-180 may be part of hardware, separate from the processing unit 110.

Further, the system 100 handles diverse assets through transparency. The core idea is that increased transparency leads to more available information which in turn creates opportunities for making optimal choices. The principle is based on the differentiation between data and information. The data represents raw facts and figures, whereas, the information is processed and structured data that is meaningful and useful for decision-making. By providing clear, accessible data on assets and market trends, the system 100 turns raw data into actionable information which allows the participants to understand asset potentials and market dynamics thoroughly.

Furthermore, with higher quality information, the participants can identify the best strategic options, ensuring decisions are not just reactive but are based on a deep understanding of assets. As information quality improves, the participants have a broader range of strategic choices thereby allowing for more nuanced and adaptable asset management strategies that can evolve with market conditions. In essence, the system's emphasis on transparency ensures that the participants have the information needed to make informed decisions, maximizing the potential for optimal asset management and value realization.

Also, the system 100 ensures a holistic approach to asset management and value realization across tangible, intangible, and alternative capital. The system 100 integrates the one or more modules that provides a unified asset register. The unified asset register catalogs all asset types with relevant attributes, facilitating comprehensive management. Further, the system 100 applies diverse criteria to assess the value of each asset type accurately. Also, the system 100 uses AI to predict market trends affecting different asset types. Furthermore, the system 100 generates actionable strategies based on asset evaluations and market forecasts.

In an embodiment, the system 100 involves sharing of net gains and long-term alignment of incentives. The system 100 ensures that all participants in a transaction or ecosystem benefit not just from individual transactions but also from an overall success and sustainability of the system 100 over time. In the system 100, a mechanism may be developed where the gains are shared among all participants, including suppliers, buyers, and the platform, in a fair and transparent manner. Few ways to achieve this could be achieved through revenue-sharing models, profit-sharing agreements, or other similar mechanisms.

In many business models, the incentives of different participants are often misaligned. For example, a platform may prioritize short-term profits over long-term sustainability, or suppliers may prioritize immediate gains over the long-term health of the ecosystem. The system 100 aims to align the incentives so that all participants are encouraged to act in ways that benefit the system 100 as a whole in the long run. This could involve setting up incentives that reward behaviors that contribute to the sustainability and growth of the system, such as quality service provision, customer retention, or ecosystem health.

In an embodiment, the system 100 relies on credentials set by a company (hiring company) to authenticate and authorize service providers. The credentials include qualifications, certifications, background checks, or any other requirements set by the company to ensure that the service provider is qualified and trustworthy. The system 100 includes an audit module which is a component responsible for conducting post-transaction audits. In other words, after a transaction (such as a service being provided by the service provider), the system 100 can review and verify the transaction to ensure that the transaction was completed according to the company's standards, contractual agreements, or other predefined criteria. The transaction may be a temporary transfer or assignment of risk. In an embodiment, the system 100 includes intangible elements of the transaction on a temporary basis.

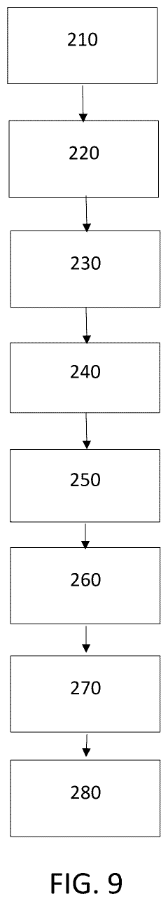

FIG. 9 illustrates a process flowchart depicting a method 200 of participation registration to final transactions, according to an embodiment of the present disclosure. At step 210, the method 200 includes a participant registration 210. The method 200 leads to steps of 220, 230, 240 and 250 including the asset declaration, asset disaggregation, the pooling of assets, and the thematic grouping respectively. At step 260, the method includes the strategy formulation. At step 270, the method 200 includes market segmentation, and finally culminating at step 280, the method 200 includes transaction completion in the digital marketplace.

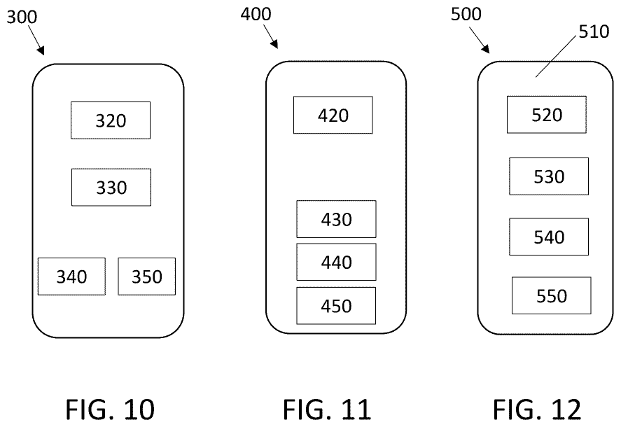

FIGS. 10-12 illustrate a plurality of user interfaces 300, 400, 500 of the system 100, according to an embodiment of the present disclosure.

In an embodiment, the registration interface 300 shows a user-friendly layout with fields for personal information 320 and asset information 330, and submission buttons 340, 350. The asset declaration interface 400 displays detailed forms for entering asset data 420, with options 430, 440, 450 for categorizing assets as tangible, intangible, or alternative. The digital marketplace interface 500 shows a simulated screen 510 with listings of assets 520, search filters 530, transaction functionalities 540, and a user rating section 550.

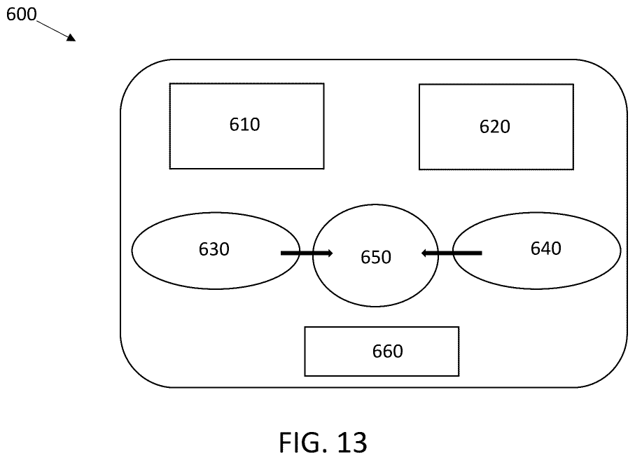

FIG. 13 illustrates a signal flow chart depicting a hybrid marketplace 600 for optimizing asset transaction, according to an embodiment of the present disclosure. The hybrid marketplace 600 seamlessly combines traditional and alternative market strategies to optimize asset transactions. The hybrid marketplace 600 may include an investment module 610, a mutuals module 620, a supply and demand capital 630, 640, and a coordination module 650.

In an embodiment, the investment module 610 may be utilized for formulating investment themes and templates. The investment module 610 employs digital matchmaking techniques to align the supply of assets with demand and facilitating efficient transactions tailored to the market's evolving needs. Further, the mutuals module 620 serves as a foundation for a theme distribution network. The mutuals module 620 allows for an opting-in of asset pools. The mutuals module 620 represents a collaborative platform where assets are pooled and shared, enhancing asset utilization across the participants.

Furthermore, the supply and demand capital 630, 640 includes illustrating the dynamic interaction between supply capital 630 and demand capital 640. The supply and demand capital 630, 640 underscores a contribution of both interface owners to transactional capital. The supply and demand capital 630, 640 further highlights an inventory of underutilized assets which is a crucial form of supply capital and is effectively mobilized.

The coordination module 650 is utilized to match the supply with the demand for transactional capital thereby ensuring that the assets are allocated where they can generate the most value. The coordination module 650 plays a vital role in the efficient management of assets within the marketplace. Further, the hybrid marketplace 600 may further include other parts 660 which represents an opted-in and pledged abundance of underutilized value from various entities, including individuals, businesses, governmental bodies, educational institutions, and other organizations. The parts 660 showcases the system's ability to harness and mobilize underutilized assets for greater economic efficiency and innovation.

In an exemplary embodiment, the system 100 may also include an artificial intelligence (AI) optimization engine, a digital marketplace, and a collaboration portal. In the AI optimization engine, the system 100 utilizes various AI algorithms to analyze asset characteristics, market demand, and collaboration opportunities. The AI optimization engine generates optimization strategies by identifying underutilized assets and potential synergies between entities. The AI optimization engine enables real-time, data-driven decision-making, enhancing asset valuation and strategic deployment across various sectors. Further, the digital marketplace acts as a platform for transactions involving the exchange, lease, or sale of assets and services which is supported by smart contracts. The digital marketplace facilitates a transparent and efficient marketplace where assets can be dynamically matched with demand, optimizing resource utilization and accessibility. The system 100 thereby ensures integrity, security, and compliance in all transactions.

The collaboration portal may provide a dedicated space for entities to share insights, resources, and opportunities. The collaboration portal encourages the formation of collaborative networks, fostering a community-oriented approach to asset management. The collaboration portal breaks down traditional silos, enabling cross-sector collaboration and the collective enhancement of asset value through shared insights and resources.

In one example, a company conducts numerous candidate interviews for a position but can only hire one. Instead of letting the insights from these interviews go to waste, the company shares summarized feedback on the digital marketplace, helping other companies find qualified candidates faster and more efficiently. This not only accelerates the hiring process for other companies but also provides valuable feedback to candidates, enhancing their prospects for future opportunities.

In another example, commercial real estate companies list available office spaces on the digital marketplace. Startups and small businesses searching for temporary or flexible office solutions can easily find and access these spaces, optimizing the use of real estate and supporting the growth of smaller enterprises.

In yet another example, manufacturing firms with idle production capacity share this information through the system. Smaller companies or entrepreneurs in need of manufacturing services but lacking facilities can partner with these larger firms, creating a win-win situation where unused capacity is monetized, and smaller entities gain access to essential production resources.

In an example, retailers with surplus stock list items on the marketplace, where other businesses, including smaller retailers and non-profits, can purchase goods at discounted rates. This approach not only reduces waste but also aids in inventory liquidation, providing a channel for retailers to free up storage space and capital.

In another example, entities holding vast but underutilized data sets, such as market research or anonymized patient data, share this information on the platform. Researchers, startups, or companies in complementary sectors can access this data, unlocking new insights, products, or services that drive innovation and development.

In yet another example, educational and research institutions with specialized but infrequently used equipment make these resources available to external parties. This sharing supports collaborative research, innovation, and the efficient use of expensive assets, benefiting the broader scientific and educational community.

In an embodiment, the system 100 and method may include a feedback mechanism for the participant to rate a transaction experience and provide suggestions. The feedback mechanism allows participants (such as service providers, buyers, or sellers) to provide feedback on their transaction experience. The feedback may include ratings (such as star ratings or numerical ratings) and comments about various aspects of the transaction, such as the quality of service, timeliness, communication, and overall satisfaction. The participants can rate their transaction experience based on their satisfaction level. Higher ratings indicate a more positive experience, while lower ratings indicate a less satisfactory experience. These ratings can help other participants make informed decisions about future transactions and can also provide valuable insights to the platform or system operator about the quality of transactions being facilitated.

In addition to rating the transaction, the participants can also provide suggestions for improvement. These suggestions can range from minor improvements in the transaction process to more significant changes in policies or procedures. By collecting and analyzing these suggestions, the system operator can identify areas for improvement and make changes to enhance the overall user experience.

In an embodiment, the system 100 may also include an asset aggregation and analysis module, an environmental, social, and governance (ESG) integration engine, a decentralized finance (DeFi) transaction module, an AI-based decision-making engine, and a hybrid blockchain framework. The asset aggregation and analysis module may serve as an entry point for participating entities thereby enabling them to aggregate a wide array of assets, including financial resources, intellectual property, and physical or digital resources. The asset aggregation and analysis module employ sophisticated data analysis techniques to assess the current utilization and potential value of these assets within a collective framework.

The ESG integration engine may be adapted to incorporate an environmental, social, and governance (ESG) scoring to evaluate assets not just on financial metrics but also on their sustainability and ethical impact. The DeFi transaction module leverages the smart contracts for automating and securing financial exchanges thereby reducing a need for intermediaries and enhancing transaction efficiency. The AI-based decision-making engine adapted to refine asset-opportunity matching algorithms over time, learning from transaction outcomes, and evolving market conditions to continuously improve optimization strategies. The hybrid blockchain framework intelligently decides between on-chain and off-chain processing to optimize for transaction speed, cost, and environmental footprint, addressing one of the critical challenges in current blockchain applications.

The operational workflow may now be explained to maximize the efficiency and efficacy of asset optimization and transaction execution across the network of participating entities. The participating entities input their assets into the asset aggregation module where assets are categorized and assessed for their current utilization and potential optimization opportunities. The ESG Integration Engine evaluates these assets against ESG criteria, assigning scores that reflect their sustainability and ethical impact. Further, the AI-based decision-making engine may analyze the aggregated and ESG-scored assets to identify optimization opportunities. This includes matching assets with investment opportunities, collaborative ventures, or other value-enhancing propositions. The AI-based decision-making engine may utilize machine learning algorithms to refine its matching criteria continuously, learning from the outcomes of previous matches to improve future recommendations.

Once an optimal match is identified, the DeFi Transaction Module orchestrates the execution of the transaction. This could involve asset exchange, investment, or other financial operations, executed securely and transparently using blockchain technology. The smart contracts automate the compliance and execution processes, ensuring that all transactions adhere to agreed-upon terms and conditions. The outcomes of executed transactions, including any generated value or returns, are redistributed among the participating entities according to predefined rules or agreements. Feedback from these transactions is fed back into the system thereby allowing the AI algorithms to update and refine their decision-making processes for future transactions.

The system 100 may promote a more efficient, transparent, and sustainable approach to asset management and optimization across a network of entities. Also, the system 100 may facilitates collective growth and value creation by leveraging the combined strengths and assets of participating entities. Additionally, the system 100 enhances adaptability and responsiveness of financial strategies to market changes and emerging opportunities through AI-driven insights. Further, the system 100 contributes to a broader adoption of ESG principles in investment practices thereby aligning financial activities with broader social and environmental objectives.

Further, the system 100 may support any type of digital currency. The digital cash does not wear out or get physically damaged, and less susceptible to theft when properly secured digitally. Further, the system 100 supports digital formats that enable a handling of large transactions more efficiently and safely without the physical limitations and security risks associated with large volumes of cash. Further, the digital transactions can be tracked, reducing anonymity and making it harder to use for illegal activities like money laundering. This traceability also aids in financial oversight and regulatory compliance. While the digital currency doesn't inherently earn interest, the digital currency can be integrated into financial products that do, and the digital currency doesn't lose physical integrity over time.

Also, the digital currency reduces costs related to the production, transportation, and maintenance of physical currency, potentially lowering overall economic costs. By eliminating the need for manufacturing physical money, digital cash significantly reduces environmental impact associated with the production and disposal of currency. The digital currency offers greater convenience in the digital era, supporting instant transactions, seamless online payments, and integrated financial management tools. The digital currency enhances transactional efficiency and security thereby mitigating several economic and environmental costs of physical currency, and aligns well with the demands of modern financial systems, marking a significant shift in how economies operate.

The system 100 and methods disclosed in the present disclosure not only harnesses the power of artificial intelligence for asset management and optimization but also incorporates a digital marketplace to facilitate transactions. The system 100 offers a holistic approach to managing tangible, intangible, and alternative assets, capable of dynamically adapting to market changes, pooling assets into thematic groups for enhanced valuation, and ensuring efficient, secure transactions. The present disclosure represents a significant leap forward in asset management technology, addressing the current gaps in the field and paving the way for innovative, sustainable, and economically efficient asset utilization.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

What is claimed is:

1. A method for asset valuation and optimization, the method implemented through a set of instructions executed by a processor, the method comprising the steps of:
registering a participant;
capturing asset declarations representing assets of the participant;
disaggregating the captured asset declarations into similar asset groups based on predefined parameters associated with an asset class and a type of the participant;
classifying the similar asset groups into a plurality of thematic pools;
synthesizing actionable strategies for each of the thematic pools; and
categorizing the actionable strategies into supply and demand segments, aligning with current market needs and capability of the participant.

2. The method according to claim 1, including conducting an interview between a company and the participant and accessing an interview data by the company and the participant wherein the interview data includes particulars of the interview.

3. The method according to claim 1, wherein by encompassing tangible, intangible, and alternative capital, the method ensures a more holistic approach to asset management and value realization.

4. The method according to claim 1, wherein the method dynamically adjusts to market changes and inputs of the participant thereby makes the system highly adaptable and forward-looking.

5. The method according to claim 1, wherein an integration of a digital marketplace with advanced matching algorithms and smart contract technology ensures efficient, transparent, and secure transactions.

6. The method according to claim 5, wherein the transactions include contract execution and compliance monitoring.

7. The method according to claim 1, wherein the thematic pools are based on any of complementary, adjacent, or tangential characteristics of the similar asset groups.

8. The method according to claim 1, including verification of the assets declared and protecting sensitive data related to the participant to ensure compliance with data privacy regulations.

9. The method according to claim 1, including a feedback mechanism for the participant to rate a transaction experience and provide suggestions.

10. A system for asset valuation and optimization, the system including:
a participant registration module configured to register a participant and assets declared by the participant,
an asset disaggregating module configured to disaggregate the declared assets into smallest practical units and categorizes the declared assets into similar assets for optimized management and valuation;
an artificial intelligence (AI) pooling module configured to pool the similar assets into thematic pools, wherein the thematic pools are based on one or more of complementary, adjacent, or tangential characteristics;
a thematic analysis module;
a strategy formulation module configured to formulate a strategy based on a current market condition and anticipate future trends from the thematic pools, wherein the assets are dynamically reevaluated, emerging opportunities are identified, and strategies are adjusted in accordance with the reevaluated assets and new opportunities based on the current market condition and the future trends;
a market segmentation module configured to integrate a digital marketplace platform for matching a supply and demand of the declared assets; and
a transaction module configured to facilitate transactions of the declared assets.

11. The system according to claim 10, wherein the assets include tangible assets, intangible assets like skills and intellectual property, and alternative capital such as unused time or resources.

12. The system according to claim 10, wherein the strategy formulation module further configured to synthesize actionable strategies from thematic pools and categorizes the declared assets into supply and demand segments, aligning with market needs and participant capabilities.

13. The system according to claim 10, including an interview module for conducting an interview between a company and a participant wherein the interview module accesses a data related to interview particulars accessible by the company and the participant for the benefit of the company and the participant.

14. The system according to claim 10, wherein the system allows gradual building of value through transparency.

15. The system according to claim 10, wherein for a service provider hired by a company, the system relies on credentials set by the company.

16. The system according to claim 15, comprising an audit module to perform a post transactions audit.

17. The system according to claim 10, including pooling of excess capacity in lines of credit is utilized with consideration of quality of risk management practices.

18. The system according to claim 10, wherein one the transactions is a temporary transfer or assignment of risk.

19. The system according to claim 10, wherein the system includes intangible elements of a transaction on a temporary basis.
